(19) United States
(12) Patent Application Publication
(10) Pub. No.: US 2021/0073653 A1
(43) Pub. Date: Mar. 11, 2021

(54) INFORMATION TECHNOLOGY SERVICE MANAGEMENT SYSTEM REPLACEMENT

(71) Applicant: MICRO FOCUS LLC, Santa Clara, CA (US)

(72) Inventor: Stephane Herman Maes, Santa Clara, CA (US)

(73) Assignee: MICRO FOCUS LLC, Santa Clara, CA (US)

(21) Appl. No.: 16/568,065

(22) Filed: Sep. 11, 2019

(51) Int. Cl. G06N 5/02; G06N 20/00

(52) U.S. Cl. CPC G06N 5/02; G06N 20/00

(57) ABSTRACT

An apparatus may include a processor that may access first Information Technology Service Management (ITSM) information of a first ITSM system to be retired. The apparatus may train, based on the first ITSM information, a routing model used to route tickets. New tickets in the second ITSM system may be routed based on the routing model. Results of the routing may be used to retrain the routing model. The apparatus may also determine a knowledge base from the first ITSM information to resolve requests in the second ITSM system. Results of the resolutions requests such as tickets or queries determined from the knowledge base may be used to update/retrain the knowledge base. The second ITSM system may therefore use machine learned models seeded from the first ITSM information and retrain the models based on usage and evaluation of results of routing and resolutions of the second ITSM system.

### BACKGROUND

An information technology service management (ITSM) system may provide a catalog of services that an information technology (IT) department offers to end users of an organization. For example, an end user may request a service via the ITSM system. The service may include a fulfillment service, an incident service, and/or other types of services offered by the IT department. The request for a fulfillment service may include a request to fulfill (R2F) an item. The request for an incident service may include a request to resolve a problem (such as an incident request) or make a change (such as a change request). In some examples, the ITSM system may generate a ticket to document the requested service as well as provide tracking information for ticket status. IT personnel or others may route the ticket for resolution of the requested service using the ITSM system. The ticket may be closed when the service request has been resolved. The ITSM system may generate ITSM information that includes the ticket, routing of the ticket, resolution of the ticket, and/or other ticket-related information. In some examples, the ITSM information may include a catalog of services to provide, items for fulfillment, workflows for fulfilling an item such as approval information used to approve such fulfillment, and/or other information relating to an R2F (Request to fulfill).

### BRIEF DESCRIPTION OF THE DRAWINGS

Features of the present disclosure may be illustrated by way of example and not limited in the following figure(s), in which like numerals indicate like elements, in which:

FIG. 1 shows a block diagram of an example apparatus that analyzes and learns from first ITSM information from a first ITSM system to be applied to a second ITSM system;

FIG. 2A shows a block diagram of an example first ITSM system to be retired and an example second ITSM system to replace the first ITSM system;

FIG. 2B shows another block diagram of an example first ITSM system to be retired and an example second ITSM system to replace the first ITSM system;

FIG. 3 shows a block diagram of an example apparatus for indexing information from ITSM repositories to determine a knowledge base and machine-learning (ML) from the ITSM repositories to determine a routing model;

FIG. 4 shows a block diagram of an example operation of containerized services from a first ITSM system at a second ITSM system;

FIG. 5 depicts a flow diagram of an example method of ML routing instructions of ITSM tickets based on machine-learning (ML) from information of a first ITSM system to be retired; and

FIG. 6 depicts a block diagram of an example non-transitory machine-readable storage medium of pre-building an index of a knowledge base from a first ITSM system to be retired to be applied to a second ITSM system to replace the first ITSM system.

### DETAILED DESCRIPTION

For simplicity and illustrative purposes, the present disclosure may be described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” may be intended to denote at least one of a particular element. As used herein, the term “includes” means includes but not limited to, the term “including” means including but not limited to. The term “based on” means based at least in part on.

Migrating ITSM information from one ITSM system to a replacement ITSM system may be difficult due to the custom nature of the data in each ITSM system. Processes and data models used by each ITSM system may be different from one another. For example, descriptions of pricing, approval, business processes involved in fulfillment, processing ticket routing, case exchange, expertise tags (indicating skill levels), may be different between the two ITSM systems. To migrate the data, the data may be transformed to models that are compatible with the replacement ITSM system. However, doing so may be time consuming and error prone or incompatible with how processes are handled in the target ITSM. As such, many migration attempts fail, do not deliver as expected, or take longer than expected. Thus, oftentimes IT administrators may rebuild the data (which is also time consuming) or only migrate some of the data—such as catalogs and approvals—of the prior ITSM system while abandoning other data such as history of past tickets. Abandoning the data may result in loss of knowledge that was gained through operation of the ITSM system or having to re-implement the processes and content. For example, the data may include ITSM information such as routing information (who resolved particular tickets) and resolution information (how particular tickets were resolved and other related content like documentation and tutorials) as well as relevant knowledge information about all ITSM aspects and services. This valuable information would be lost if the ITSM information is not otherwise migrated to the replacement ITSM system.

Disclosed herein are apparatuses and methods for analyzing and learning from first ITSM information of a first ITSM system to be retired (no longer used and to be replaced) so that such analysis and learning may be applied to a second ITSM system that is to replace the first ITSM system. Such analysis and learning may be used by the second ITSM system without having to migrate all or most of the first ITSM information. The apparatuses and methods may further make the first catalog information of the first ITSM system for servicing requests (such as R2F) visible at the second ITSM system. As such, some or all of the first catalog of service items may be visible at the second ITSM system. In some examples, the second ITSM system may include a second catalog of service items specific to the second ITSM system. Thus, information from the first catalog and the second catalog may co-exist at the second ITSM system.

In an example, an apparatus may apply machine-learning (ML) techniques to the first ITSM information so that operations and knowledge from the first (retired) ITSM system may be extracted and learned (i.e. modeled) to be retained in the second (replacement) ITSM system. The apparatus may facilitate easier transition from the first ITSM system to the second ITSM system since operations and knowledge of the first ITSM system are retained in the second ITSM system. Such retention may eliminate or reduce the need to manually configure the second ITSM system or manually input some of the first ITSM information (or usage experience such as learned routing or learned KM relevant documents) into the second ITSM system.

The apparatus may train an ML model to learn routing and resolution information from the first ITSM system for use in operations of the second ITSM system. For example, routing information may be modelled from the first ITSM system to guide ticket routing in the second ITSM system. In another example, resolution and other information from the first ITSM information may be used to determine a knowledge base that may be queried or otherwise used to provide resolutions for tickets in the second ITSM system and/or provide responses to queries relating to IT issues.

In this manner, the second ITSM system is not required to learn operational or knowledge-based information based solely on its own operations (which may take weeks, months, or more to rebuild a sufficient knowledge of the domain or processes of the enterprise). The second ITSM system also may not need to reimplement the operational or knowledge-based information in business process and heuristics to repeat what was done in the first ITSM system. Rather, the second ITSM system may be able to immediately (after training) leverage operational and knowledge details from the first ITSM system. As such, the second ITSM system may operate using knowledge learned (including ticket resolution and knowledge management) from the first ITSM system while providing enhanced features and functionality of the replacement ITSM system.

Furthermore, the apparatus may use containers that containerize services of the first ITSM system so that such containerized services may continue to execute (if this option is desired by an organization that uses the ITSMs) after the first ITSM system has been retired. The containerized services may include R2F functions of the first ITSM system. A container with the containerized services may be used by the second ITSM system. For example, a container that containerizes a service of the first ITSM may be bundled with containers that containers services of the second ITSM. In this manner, the service of the first ITSM may continue to be made available at the second ITSM without having to continue to run the first ITSM to use that service. An R2F corresponding to the containerized services of the first ITSM system may be received at the second ITSM system and delegated to the container with the appropriate containerized services. In this manner, both R2F and other containerized services of the first ITSM system may continue to be serviced by the second ITSM system (in some examples alongside R2F services of the second ITSM system), permitting a gradual transition from the first to the second ITSM system for R2F and other containerized services.

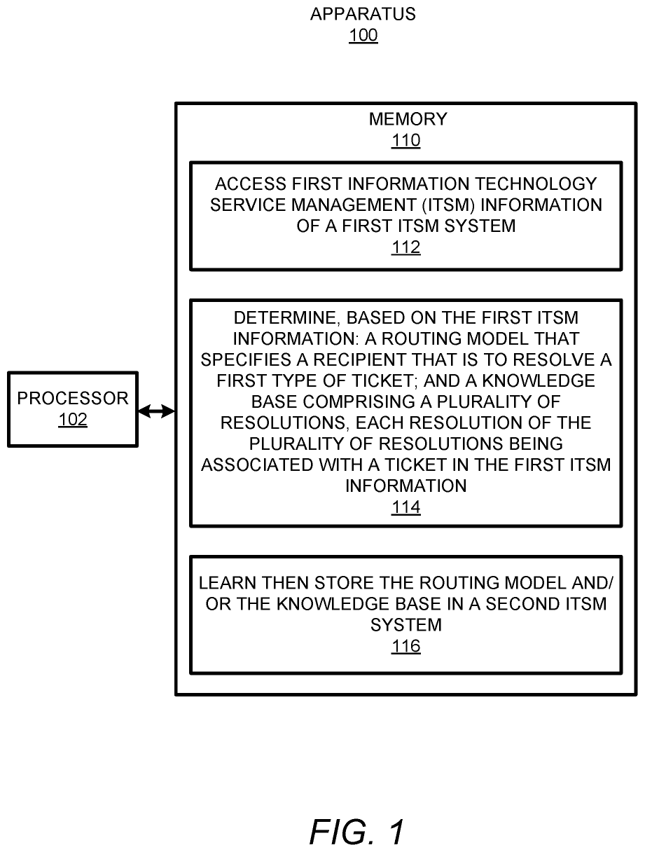

FIG. 1 shows a block diagram of an example apparatus 100 that may analyze and learn from first ITSM information from a first ITSM system to be applied to a second ITSM system. It should be understood that the example apparatus 100 depicted in FIG. 1 may include additional features and that some of the features described herein may be removed and/or modified without departing from the scope of the example apparatus 100.

The apparatus 100 shown in FIG. 1 may be a computing device, a server, or the like. As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. Although the apparatus 100 has been depicted as including a single processor 102, it should be understood that the apparatus 100 may include multiple processors, multiple cores, or the like, without departing from the scope of the apparatus 100 disclosed herein.

The apparatus 100 may include a memory 110 that may have stored thereon machine-readable instructions (which may also be termed computer readable instructions) 112-116 that the processor 102 may execute. The memory 110 may be an electronic, magnetic, optical, or other physical storage device that includes or stores executable instructions. The memory 110 may be, for example, Random Access memory (RAM), an Electrically Erasable Programmable Read-Only Memory (EEPROM), a storage device, an optical disc, and the like. The memory 110 may be a non-transitory machine-readable storage medium, where the term “non-transitory” does not encompass transitory propagating signals. It should be noted that the routing model and the knowledge base described with respect to FIG. 1 may each be based on machine-learning from a first ITSM and continuously retrained based on usage of a second ITSM, as will be described herein.

Referring to FIG. 1, the processor 102 may fetch, decode, and execute the instructions 112 to access first ITSM information of a first ITSM system. The first ITSM information may include information related to ticket and other ITSM service processing. For example, the first ITSM information may include details relating to a ticket. Such details may include an identity of the requester, a date/time that the request was made, a type of service requested (which may define the type of ticket), resolution information, a recipient to which the ticket was routed, and/or other information related to the ticket.

The processor 102 may fetch, decode, and execute the instructions 114 to determine (or learn or update), based on the first ITSM information: a routing model that specifies a recipient that is to resolve a first type of ticket and a knowledge base including a plurality of resolutions, each resolution of the plurality of resolutions being associated with a ticket in the first ITSM information.

The routing model may specify a recipient based on a routing parameter, which may specify a department, a specific IT user, a skill useful to resolve the ticket, and/or other information used to determine a recipient of a given request type of the ticket (or process that should handle it). It should be noted that if the recipient is a department or other entity that is not an individual, the department or other entity may further assign the ticket to a particular user. The knowledge base may serve as a resource that may be queried by users or interrogated to determine recommendations for actions. For example, IT users may query the knowledge base (through a chat-bot or other query interface) to determine potential courses of action to take with a given ticket. End users (requesters) may likewise query the knowledge base for self-help. The processor 102 may use the knowledge base to make proactive recommendations or automated resolutions (resolution without user intervention) for a given ticket. It should be noted that the routing model and/or the knowledge base may be determined without importing the first ITSM information to the second ITSM system such as without copying the first ITSM information to the ITSM repository of the second ITSM system. In this manner, the processor may analyze and learn from the first ITSM information so that such knowledge may be applied to route and service new tickets in the second ITSM, as well as provide a knowledge base used to resolve the new tickets.

In some examples, to determine the routing model, the processor 102 may access a plurality of tickets in the first ITSM information. The processor 102 may determine a recipient to which each of the plurality of tickets was assigned and may train the routing model based on the determined recipient. For example, based on the first ITSM information, the processor 102 may determine that a certain recipient is routed certain types of requests. The processor 102 may make other types of correlations between ticket-related information and recipients as well, such as severity of an issue, time of day/day of week, skill level of the recipient, and/or correlations.

In some examples, to determine the routing model, the processor 102 may access a heuristic rule to be followed to route the first type of ticket. In these examples, the heuristic rule may trigger a routing recommendation based on previously observed ticket routing. In some examples, the heuristic rule may be based on a condition that when satisfied may trigger a routing decision. For example, the condition may include that “if a certain request type is submitted, route to a certain recipient” in which the condition is based on observed ticket routing. Other conditions and combination of conditions may be used as well, such as “if a certain request type is submitted and the priority level is high, route to a certain recipient.”

The processor 102 may fetch, decode, and execute the instructions 116 to learn then store the routing model and/or the knowledge base in a second ITSM system. In some examples, the second ITSM system may be to replace the first ITSM system. For example, new tickets in the second ITSM system may be routed or recommended to be routed to recipients based on the routing models. Likewise, responses to queries from users relating to ticket resolution and/or automated recommended resolutions to new tickets or other issues in the second ITSM system may be determined based on the knowledge base.

In some examples, the processor 102 may periodically retrain (update) the routing model based on ticket routing in the second ITSM system as well. Thus, in these examples, the routing model may be initially trained from ticket routing in the first ITSM system and used to route tickets (or suggest ticket routing) in the second ITSM system. As tickets are routed in the second ITSM system, the processor 102 may retrain or otherwise update the routing model based on new tickets in the second ITSM system. Alternatively, the processor 102 may conduct supervised or unsupervised learning based on whether the ticket has been rerouted.

To illustrate, the second ITSM system may access a first ticket submitted to the second ITSM based on ML from the first ITSM system. The second ITSM system may predict a routing (based on the routing models) and route the ticket or identify information predicted to be relevant (based on the knowledge base (KM)). If the ticket was resolved by a recipient of the routing or the information is deemed to be relevant, the second ITSM system may confirm that the routing or the predicted relevance was accurate. On the other hand, if the ticket was resolved by another recipient such as being re-routed manually by a human user or if the information was not relevant, then the second ITSM system may be improved based on the failed routing or predicted relevance.

Such retraining may be similar to the way in which the routing model was trained using the first ITSM information, except that new routing information from the second ITSM system may also be used for training and that such training may continue during usage of the second ITSM (e.g. in unsupervised mode) after the first ITSM has been retired.

In some examples, some of the services of the first ITSM system may be supported by the second ITSM system. For instance, the first ITSM system may use a containerized service in a container. The containerized service may include a R2F service associated with a catalog of service items such as products or services that may be fulfilled by the IT department. The container may be instantiated (e.g., an instance of the container created) at the second ITSM system. A request for the containerized service received at the second ITSM system may be serviced based on the instantiated container. As such, some of the services from the first ITSM system may be supported by the second ITSM system, facilitating an easier transition from the first ITSM system to the second ITSM system for certain services such as R2F services.

It should be noted that the instructions 112-116 may be executed prior to deploying the second ITSM system. That is to say, the second ITSM system may be deployed after the knowledge management and routing model has been determined from the first ITSM information. In this manner, the second ITSM system may be deployed already equipped with the knowledge and routing determined from the first ITSM system.

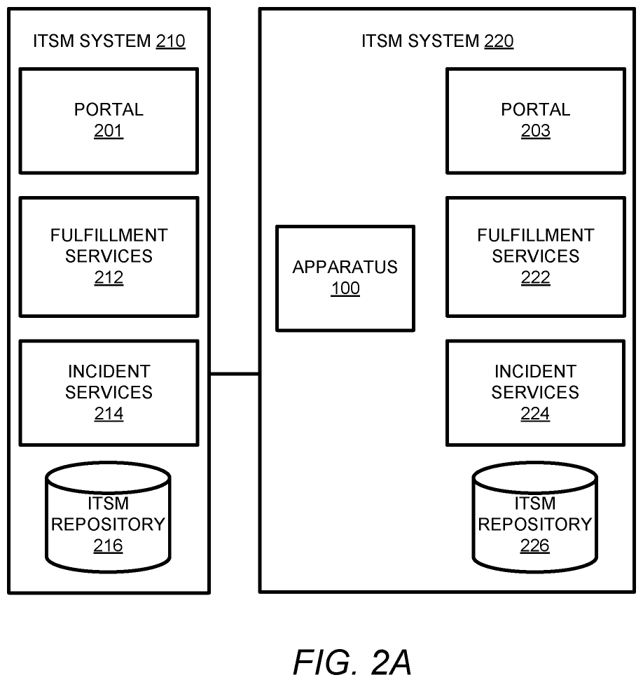

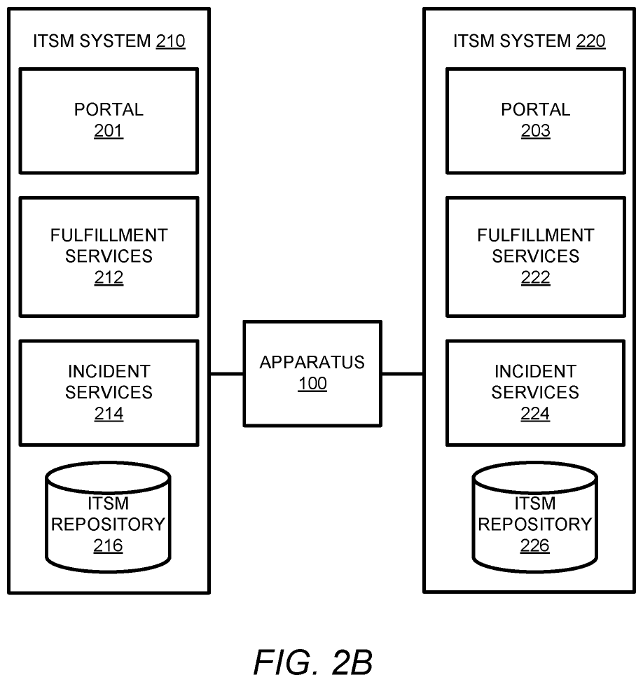

FIG. 2A shows a block diagram of a first ITSM system (such as ITSM 210) to be retired and a second ITSM system (such as ITSM 220) to replace the first ITSM system, according to an example of the disclosure. ITSM 210 may include a portal 201, fulfillment services 212, incident services 214, and an ITSM repository 216. ITSM 220 may similarly include a portal 203, fulfillment services 222, incident services 224, and an ITSM repository 226.

The portal 201 may provide an interface for requesters to submit a request for a fulfillment service 212, an incident service 214, and/or other requests. The interface of the portal 201 may be in the form of a web-based or other graphical user interface, a telephone system, a mobile application, and/or other system or service to obtain requests from users.

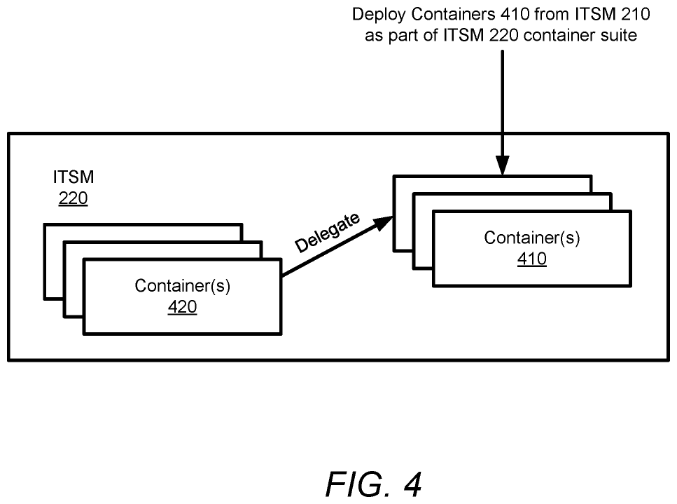

The fulfillment service 212 may service a request to fulfill (R2F) an item from among a catalog of items such as services or products. Upon submission of a request for the fulfillment service 212, a workflow or other operations may be initiated that approve or deny the request, cause the request to be fulfilled, log the result of the request, and/or other perform functions. In some examples, the workflow may include an automated (computer-executed) set of instructions to process fulfillment. The R2F and related information may be stored in the ITSM repository 216. In some examples, some or all of the fulfilment services 212 may be containerized. Such containerized fulfillment services 212 may be ported to the ITSM 220, as will be described with respect to FIG. 4.

An incident service 214 may fulfill a request to resolve an incident such as a problem or other issue that may interrupt normal operation of an IT-related item. The incident service 214 may attempt to resolve the problem or other issue so that normal operation is restored. Examples of an incident include an end user device failure, electronic mail delivery issue, network access problem, and/or other types of issues that may disrupt normal operation of IT-related items. In some examples, the portal 201 may cause a ticket for a request for an incident service 214 to be generated.

A ticket as used herein may include a set of data that defines a request and related information stored in a repository such as the ITSM repository 216. The ticket may be generated with service request information such as a date, an identity or other information of the requester, the service requested (fulfillment service 212, incident service 214, and/or other service), comments or other notes from the requester, comments or other notes from an operator (for telephone-based requests), and/or other information relevant to the request.

In some instances, the portal 201, an IT user, and/or others may route the ticket to an appropriate recipient (such as another IT user or automated service) to handle the request. The recipient of the ticket or others may service the request, annotate the ticket with annotation information (which may include resolution information that specifies how a ticket was resolved, further action, and others), adjust a status of the ticket, re-route the ticket to another recipient, and/or otherwise update the status of the request. In some instances, the recipient, the requester, or others may close the ticket when the request has been resolved.

The ITSM 210 may store ITSM information that relates to the ticket (also referred to as “ticket information”), including the service request information, routing information (including the recipient to which the ticket was assigned and any re-routing by the recipient or subsequent recipients), annotation information, status information, and/or other information related to the ticket. For example, the ITSM 210 may store the ticket information in the ITSM repository 216. As such, the ITSM repository 216 may include historical ticket information, including how and whether the ticket was resolved, who resolved the ticket, and/or other information related to requests submitted to the ITSM 210.

The ITSM 220 may include a similar portal 203, fulfillment services 222, incident services 224, and ITSM repository 226, the details of which are omitted as these components may be similar to their counterparts of the ITSM 210. It should be noted, however, that the particular content, formatting, data modeling, or other aspect of these components may differ between the ITSM 210 and ITSM 220. At least partly because of the differences between the ITSM 210 and ITSM 220, a data dump from the ITSM repository 216 to the ITSM repository 226 may not result in usefully migrating all the ITSM information from the ITSM repository 216.

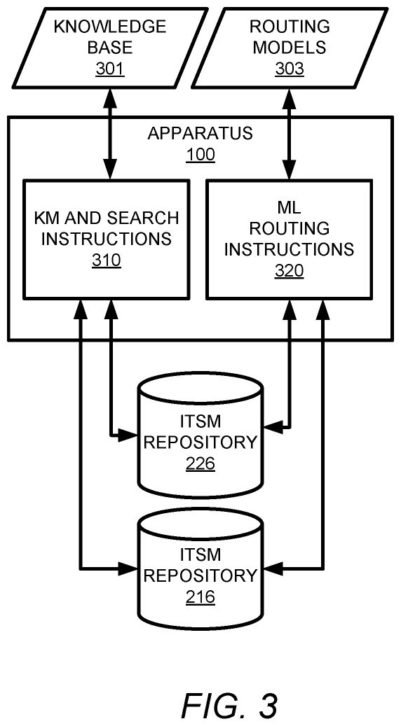

As will be described in further detail with respect to FIG. 3, the apparatus 100 may analyze the ITSM information in the ITSM repository 216 to generate knowledge bases and apply ML to determine ticket routing for incidents. By analyzing and learning from the ITSM information in the ITSM repository 216, the apparatus 100 may leverage the knowledge and routing information from operation of the ITSM 210 while mitigating the need to migrate the ITSM information. The apparatus 100 may apply such knowledge and routing information to the ITSM 220, effectively bootstrapping the ITSM 220 using operational knowledge from the ITSM 210.

It should be noted that although apparatus 100 is illustrated in FIG. 2A as integrated with the ITSM 220 (in which case the ITSM 220 performs the operations of apparatus 100 described herein), the apparatus 100 may be a standalone device as illustrated in FIG. 2B (reference numbers and descriptions for which are otherwise the same as for FIG. 2A). It should be further noted that the ITSM 210 may be retired before the ITSM 220 is deployed and before ML on the information from the ITSM 210 is conducted to learn from the operations of ITSM 210. For example, information from the ITSM 210 may be extracted and used for machine-learning. In some examples, as illustrated, the apparatus 100 may be separate from the ITSM 210 and ITSM 220. In these examples, the apparatus 100 may include a standalone tool that is able to apply knowledge and routing determined from the ITSM 210 to the ITSM 220. In some of these examples, the apparatus 100 may provide an application programming interface (not illustrated) or other interface for the ITSM 220 to determine the knowledge and routing from the ITSM 210.

FIG. 3 shows a block diagram of the apparatus 100 for indexing information from ITSM repositories 216 and 226 to determine a knowledge base 301 and ML from the ITSM repositories to determine a routing model 303, according to an example. Descriptions of the apparatus 100 in FIG. 3 will refer to elements of the apparatus 100 illustrated in FIG. 1. The apparatus 100 may include knowledge management (KM) and search instructions 310 (also referred to herein as instructions 310) and ML routing instructions 320 (also referred to herein as instructions 320). The KM and search instructions 310 and ML routing instructions 320 may each be instructions stored in the memory 110 (illustrated in FIG. 1) of the apparatus 100 and fetched, decoded and executed by the processor 102 (also illustrated in FIG. 1) to perform the operations of the smart KM and search instructions 310 and the ML routing instructions 320 described herein.

The KM and search instructions 310 may be executed by the processor 102 to provide knowledge management capability relating to ticket resolution. For example, the processor 102 may execute the instructions 310 to provide an indexing function to index and cluster ticket information from the ITSM repository 216. Such indexing function may be used to search a knowledge base 301 from the ticket information of the ITSM 210 before the ITSM 220 has been deployed. To determine the knowledge base 301, the processor 102 may execute the instructions 310 to cluster resolution descriptions based on request types specified in the ticket information. In other words, the processor 102 may analyze tickets by request type and, for each request type, analyze resolution descriptions to determine how a given request type has been resolved in the ITSM 210. In this manner, the processor 102 may learn how requests of a given request type has been resolved in the ITSM 210. For example, the processor 102 may apply text processing, and more particularly, natural language processing (NLP) techniques, on resolution descriptions to understand how a given request type has been resolved. Such resolution descriptions may have been input by recipients or others who resolve the tickets.

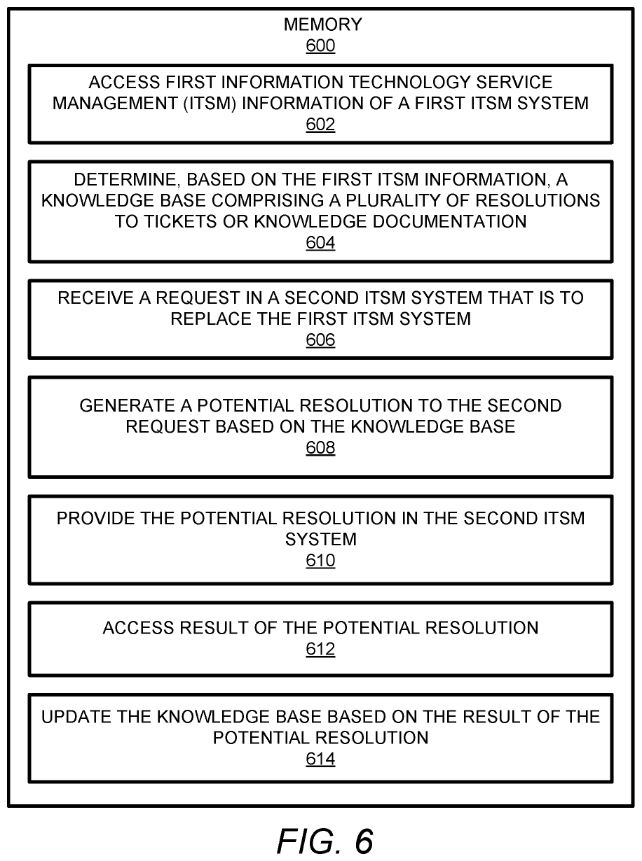

The processor 102 may execute the instructions 310 to cluster, using NLP, resolution descriptions based on the meaning of the resolution descriptions determined from the text of the resolution descriptions. For example, the processor 102 may identify, based on NLP, the meaning of the resolution descriptions input by different users that resolved different tickets of the same request type. To illustrate, assume that a first IT user that resolved a first ticket having a request type “crashing computer” provided a resolution description of “Rebooted the computer to clear offending cache” and a second IT user that resolved a second ticket having the request type “crashing computer” provided a resolution description of “Rebooting the user's device resolved the issue.” It should be noted that the instructions 310 may apply machine-learning to assess relevance of identified resolution descriptions or documents that may apply to a given request, as will be described with reference to FIG. 6.

In the foregoing examples, the processor 102 may determine that the intent of each of the two resolution descriptions was that the user performed a reboot on the computer/user's device. Other types of resolution descriptions (such as “installed latest O/S patch resolved crashing problems”) may be similarly clustered for the same request type—thus, the processor 102 may determine multiple resolutions to the same problem based on such clustering. These and other resolutions gleaned from the clustered resolution descriptions may be stored in the knowledge base 301.

In some examples, the processor 102 may execute the instructions 310 to take into account contextual information when analyzing resolution descriptions. For instance, the processor 102 may further cluster the resolution descriptions based on contextual information such as the requester, the recipient, identity of an asset (such as operating system, device make, model, and other information) having problems leading to the service request, and/or other contextual information. Continuing the previous example, a “crashing computer” request type may have different resolutions depending on contextual information, such as one operating system versus another operating system. By incorporating the contextual information of “operating system,” the apparatus 100 may generate a knowledge base 301 that is able to provide complete information relating to ticket resolution. As such, the processor 102 may execute the instructions 310 to determine a comprehensive knowledge base 301 based on ticket information from the ITSM repository 216. In some examples, the knowledge base 301 may be stored at ITSM repository 226.

In some examples, the processor 102 may determine the knowledge base 301 before the ITSM 220 may be deployed (to replace the ITSM 210) so that the ITSM 220 may already have the knowledge base 301 upon initiation of the ITSM 220. When deployed, the ITSM 220 may use the determined knowledge base 301 so that the knowledge base 301 may be applied to new tickets that are submitted to the ITSM 220. For example, IT users or others may search the knowledge base 301 for how tickets in the ITSM 210 were resolved so that new tickets in the ITSM 220 may be similarly resolved. As such, the knowledge base 301 determined from operation of the ITSM 210 may be used to resolve or guide resolution of the new tickets submitted to the ITSM 220.

In some examples, the processor 102 may execute the instructions 310 to access ticket information of the ITSM repository 226, which may be populated when the ITSM 220 has been deployed and is accepting new tickets. In this manner, the processor 102 may update the knowledge base 301 based on analysis of the ticket information relating to the new tickets from the ITSM repository 226. The processor 102 may analyze the ticket information from the ITSM repository 226 in a similar manner as the ticket information from the ITSM repository 216.

The processor 102 may execute the instructions 320 to provide routing functions that may be used to route tickets. The processor 102 may access ticket information from the ITSM repository 226 and apply ML techniques to model how tickets should be routed for the routing functions. The processor 102 may use the MICROFOCUS IDOL unified text analytics and/or other ML techniques for making routing predictions.

In some examples, the processor 102 may execute the instructions 320 to apply the foregoing and/or other ML techniques to train an ML model, such as a routing model 303 based on information from the ITSM repository 216, and then continually retrained based on information from the ITSM repository 226 (based on new tickets to the ITSM 220). For example, the processor 102 may access routing information from the accessed ticket information to train or otherwise generate the ML model such as the routing model 303. The routing model 303 may predict how tickets are to be routed. Put another way, the routing model 303 may identify a routing parameter used to route a ticket. The routing parameter may specify a department, a specific IT user, a skill useful to resolve the ticket, and/or other information used to determine a recipient of a given request type of a ticket. The routing model 303 may determine the routing parameter based on observed correlations in the ticket information. For example, the processor 102 may observe that certain request types are routed to certain recipients to determine the routing model 303. In some further examples, the processor 102 may observe that certain characteristics (such as a skill level of recipients that resolved a particular ticket) are correlated with certain tickets (or request types) to determine the routing model 303. In still some further examples, the processor 102 may take into account contextual information for routing correlations to determine the routing model 303. Such correlations may be further tested to determine whether they are statistically significant and are to be included in the routing model 303.

In some examples, when routing model 303 is determined (before the ITSM 220 is deployed), the processor 102 may execute the instructions 320 to use the routing model 303 to route new tickets once the ITSM 220 is deployed. In this manner, the model 303 may be trained to route tickets starting from a seed model in 226 learned from on old tickets from the ITSM repository 216, then it can be used to route new tickets in the ITSM 220 and based on outcome continuously learn (unsupervised training) to improve its model (stored in repository 226). Furthermore, in some examples, the routing models 303 may be re-trained based ticket information from the ITSM 226. That is, the routing model 303 may be retrained to account for new tickets in the ITSM 220 that are routed to recipients when the ITSM 220 has been deployed. As such, the processor 102 may initially train the routing models 303 using old tickets from the ITSM 210 and then periodically update the routing models 303 as new tickets are routed in the ITSM 220.

In some examples, the ITSM 220 may include a configuration management database (CMDB) interface that access configuration items (CI) from a CMDB. In these examples, the ITSM 220 may service change management based on the CI. In some examples, the CMDB for the ITSM system 210 may be transferred to the ITSM 220 or may be shared. In some examples, schema conversion may be performed to maintain the CI from the ITSM system 210.

FIG. 4 shows a block diagram of operation of containerized services from a first ITSM system (such as ITSM 210) deployed at a second ITSM system (such as ITSM 220), according to an example of the disclosure. Descriptions of the apparatus 100 in FIG. 4 will refer to elements of the apparatus 100 illustrated in FIG. 1. Fulfillment services of the ITSM system 210 may execute as microservices via a container 410 or other virtualization. For example, the container 410 may execute fulfillment services as a microservice.

In some examples, the ITSM 220 may also implement its fulfillment services as microservices executing on containers 420. In some examples, the ITSM 220 may deploy containers 410 (that execute microservices of the ITSM 210) as part of the container suite operated by the ITSM 220. In this manner, both the fulfillment services of the ITSM 210 and the fulfillment services of the ITSM 220 (as well as their respective workflows, approvals, and so forth) may be operated by the ITSM 220 via the container suite. As such, the ITSM 220 may fulfill items from either catalog of items. Doing so may permit the fulfillment services 212 to co-exist with the fulfillment services 222 at the ITSM 220.

In the illustrated example, to facilitate such co-existence of the fulfillment services, the ITSM 220 may delegate to containers 410 based on the particular item that has been requested. For example, an end user may request a first item from a first catalog of items serviced by the fulfillment services executing via containers 410. The containers 420 and/or other component (such as processor 102 executing at ITSM 220) may recognize that the first item is from the catalog of the ITSM 210 and may delegate the request to the appropriate container 410.

It should be noted that the containers 410 and/or containers 420 may, in some examples, execute separately from the ITSM 220, such as within a cloud or other remote computer environment.

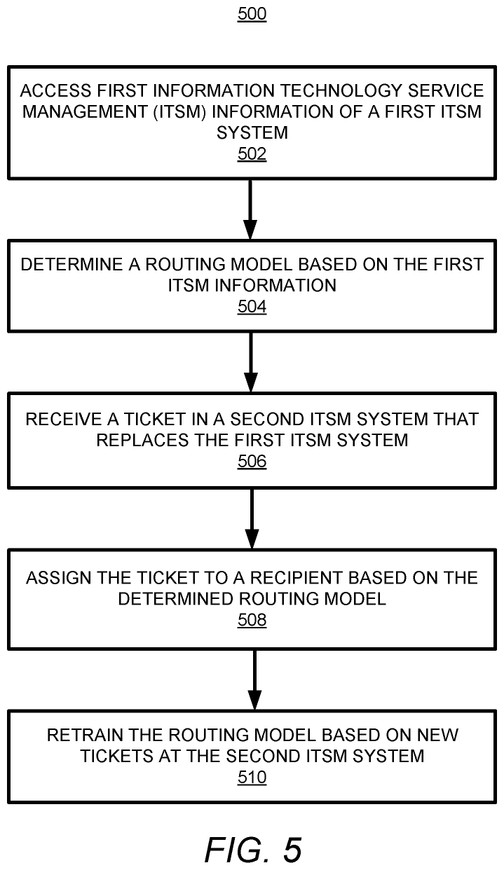

Various manners in which the apparatus 100 (such as operating at ITSM 220) may operate to perform ML routing instructions are discussed in greater detail with respect to the method 500 depicted in FIG. 5. It should be understood that the method 500 may include additional operations and that some of the operations described therein may be removed and/or modified without departing from the scope of the method 500. The description of the method 500 may be made with reference to the features depicted in FIGS. 1-4 for purposes of illustration.

FIG. 5 depicts a flow diagram of an example method 500 of ML routing of ITSM tickets based on ML from information of a first ITSM system to be retired, according to an example of the disclosure.

As shown in FIG. 5, at block 502, the processor 102 (such as operating at ITSM 220) may access first Information Technology Service Management (ITSM) information of a first ITSM system, such as ITSM 210. For example, data from the ITSM 210 (such as from ITSM repository 216) may be imported to the ITSM 220, such as at the ITSM repository 226. Such importation may include data processing to transform the data to the schema of the ITSM repository 226. If data is imported, such data may be removed upon training in some examples. In other examples, the data may not be imported, but rather accessed from the first ITSM and/or intermediate storage.

At block 504, the processor 102 may determine a routing model 303 based on the first ITSM information. For example, the routing model 303 may model ticket routing that occurred in the first ITSM system. The routing model 303 may be determined based on ML using routing information that indicates recipients to which tickets were routed. For example, the routing model 303 may be trained based on routing information from the first ITSM. The tickets may each be associated with a type of request and/or other information that may be correlated with why each of the tickets was routed to a respective recipient. The correlations between the type of request and/or other information may be used to generate the routing model 303. In some instances, the routing model 303 may be stored at ITSM repository 226 for use in the ITSM 220.

At block 506, the processor 102 may receive a ticket in a second ITSM system that replaces the first ITSM system. For example, the second ITSM system may be deployed to replace the first ITSM system, which may be retired.

At block 508, the processor 102 may assign the ticket to a recipient based on the determined routing model 303. As such, the ticket in the second ITSM system may be assigned to the recipient based on the routing model 303 determined from routing information of the first ITSM system that was replaced by the second ITSM system.

In some examples, at block 510, the processor 102 may continuously train the routing model 303 may be as new tickets are generated and routed in the second ITSM system. For example, the processor 102 may access tickets assigned to recipients in the second ITSM system and update the routing models based on the outcome of tickets assigned to recipients in the second ITSM system. The update to the routing model 303 may be based on retraining using outcome data such as whether or not a ticketed routed based on the routing model 303 was rerouted. In this manner, the routing model 303 may be subjected to continuous unsupervised training. For example, if a ticket was routed to a first recipient based on the routing model 303 and the ticket was rerouted (such as by IT or other personnel) to a second recipient, then the rerouting information may be fed back train the routing model 303 that the ticket should have been routed to the second recipient. In this manner, the routing model 303 may be seeded by the routing information from the first ITSM system (ITSM 210) and continuously trained using routing information from the second ITSM system (ITSM 220). Likewise, the knowledge base 301 may be similarly updated, as will be described with reference to FIG. 6.

Some or all of the operations set forth in the method 500 may be included as utilities, programs, or subprograms, in any desired computer accessible medium. In addition, the method 500 may be embodied by computer programs, which may exist in a variety of forms. For example, some operations of the method 500 may exist as machine-readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

FIG. 6 depicts a block diagram of an example non-transitory machine-readable storage medium 600 of pre-building an index of a knowledge base from a first ITSM system (such as ITSM 210) to be retired to be applied to a second ITSM system (such as ITSM 220) to replace the first ITSM system, according to an example of the disclosure. The non-transitory machine-readable storage medium 600 may be an electronic, magnetic, optical, or other physical storage device that includes or stores executable instructions. The non-transitory machine-readable storage medium 600 may be, for example, Random Access memory (RAM), an Electrically Erasable Programmable Read-Only Memory (EEPROM), a storage device, an optical disc, and the like. The non-transitory machine-readable storage medium 600 may have stored thereon machine-readable instructions 602-610 that a processor, such as the processor 102, may execute. The processor 102 may execute at the ITSM 220.

The machine-readable instructions 602 may cause the processor to access first Information Technology Service Management (ITSM) information of a first ITSM system, such as ITSM 210. For example, information from a knowledge base from the ITSM 210 may be imported or transferred to the ITSM 220 (which may include data processing to transform the data to the schema of the ITSM 220. If data is imported, such data may be removed upon training in some examples. In other examples, the data may not be imported, but rather accessed from the first ITSM and/or intermediate storage.

The machine-readable instructions 604 may cause the processor to determine, based on the first ITSM information, a knowledge base 301 including a plurality of resolutions to tickets of the first ITSM information and/or documentation that represents knowledge from the ITSM 210. It should be noted that the knowledge base 301 may reflect machine-learned resolutions and/or documents to resolve a request, as learned from the first ITSM information from the ITSM 210.

The machine-readable instructions 606 may cause the processor to receive a request in a second ITSM system, such as the ITSM 220, that is to replace the first ITSM system.

The machine-readable instructions 608 may cause the processor to generate a potential resolution to the request based on the knowledge base 301. For example, the processor may determine a match between the second ticket and other tickets in the knowledge base 301. Such match may be based on a type of request or other information that may be used to indicate that the second ticket and the other tickets are similar to one another. The potential resolution may be based on resolutions of the other tickets. In other examples, the processor may determine a match between a query and one or more documents or other information that answers the query based on the knowledge base 301.

The machine-readable instructions 610 may cause the processor to provide the potential resolution in the second ITSM system. The potential resolution may be provided in the form of, without limitation, a query response to a user query (whether the user is an IT user or an end user), a recommendation to resolve the second ticket, or an automated resolution to the second ticket.

The machine-readable instructions 612 may cause the processor to obtain a result of the request and the provided resolution. For example, a closing of a ticket that includes the request may indicate a successful resolution of the request, whereas a continued search for a resolution may indicate that the provided resolution did not satisfy the request.

The machine-readable instructions 614 may cause the processor continuously update the knowledge base 301 based on the results of requests. For example, if a potential resolution determined based on the knowledge base 301 is unsatisfactory (such as when the request remains open or another resolution is sought), the knowledge base 301 may be updated with this feedback to learn that such potential resolution was not relevant to the request.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, cause the processor to:
access first Information Technology Service Management (ITSM) information of a first ITSM system;
determine, based on the first ITSM information:
a routing model that specifies a target recipient that is to resolve a first type of ticket; and/or
a knowledge base comprising a plurality of resolutions or documentation; and
learn then store the routing model and/or the knowledge base in a second ITSM system.

2. The apparatus of claim 1, wherein to determine the routing model, the instructions further cause the processor to:
access a plurality of tickets in the first ITSM information;
determine a recipient to which each of the plurality of tickets was assigned; and
train a machine-learning model based on the recipient to which each of the plurality of tickets was assigned, wherein the routing model is determined based on the machine-learning model.

3. The apparatus of claim 2, wherein the instructions further cause the processor to:
access second ITSM information based on operation of the second ITSM system, the second ITSM information comprising respective results of routing a second plurality of tickets in the second ITSM;
apply machine-learning to retrain the routing model based on the respective results of routing of the second plurality of tickets in the second ITSM; and
retrain the routing model based on the retraining.

4. The apparatus of claim 1, wherein the instructions further cause the processor to:
access second ITSM information based on operation of the second ITSM system; and
update the knowledge base based on the second ITSM information.

5. The apparatus of claim 1, wherein the instructions further cause the processor to:
receive a query relating to a new ticket in the second ITSM system;
in response to the query, obtain a suggested resolution to the new ticket based on the knowledge base; and
provide the suggested resolution.

6. The apparatus of claim 5, wherein the instructions further cause the processor to:
access a result of the suggested resolution; and
update the knowledge base based on the result of the suggested resolution.

7. The apparatus of claim 1, wherein the first ITSM information is not imported into the second ITSM system.

8. The apparatus of claim 1, wherein the instructions further cause the processor to:
deploy a container comprising a containerized service used in the first ITSM system at the second ITSM system;
receive a request at the second ITSM system; and
service the requested based on the container.

9. The apparatus of claim 8, wherein the containerized service comprises a request to fulfill service.

10. The apparatus of claim 1, wherein the routing model specifies an individual, a department, or an organization that is to resolve the first type of ticket.

11. The apparatus of claim 1, wherein the apparatus is a standalone device separate from the second ITSM or is part of the second ITSM.

12. A method comprising:
accessing, by a processor, first Information Technology Service Management (ITSM) information of a first ITSM system;
determining, by the processor, a routing model based on the first ITSM information;
receiving, by the processor, a ticket in a second ITSM system that replaces the first ITSM system; and
assigning, by the processor, the ticket to a recipient based on the determined routing model.

13. The method of claim 12, further comprising:
accessing, by the processor, second ITSM information based on operation of the second ITSM system, the second ITSM information comprising respective results of routing of a second plurality of tickets in the second ITSM;
applying, by the processor, machine-learning to retrain the routing model based on the respective results of routing of the second plurality of tickets in the second ITSM; and
retraining, by the processor, the routing model based on the retraining.

14. The method of claim 12, further comprising:
generating, by the processor, a knowledge base based on the first ITSM information, the knowledge base comprising a plurality of resolutions, each resolution of the plurality of resolutions being associated with a first type of ticket in the first ITSM system or documentation related to resolution of requests.

15. The method of claim 14, further comprising:
determining, by the processor, that a type of the ticket matches the first type of ticket; and
generating, by the processor, a suggested resolution to the ticket based on the plurality of resolutions.

16. The method of claim 14, further comprising:
accessing, by the processor, second ITSM information based on operation of the second ITSM system; and
updating, by the processor, the knowledge base based on the second ITSM information.

17. The method of claim 12, wherein assigning the ticket to the recipient comprises:
assigning the ticket to an individual, a department, or an organization.

18. A non-transitory computer readable medium on which is stored machine readable instructions that when executed by a processor, cause the processor to:
access first Information Technology Service Management (ITSM) information of a first ITSM system;
determine, based on the first ITSM information, a knowledge base comprising a plurality of resolutions, each resolution associated with a ticket in the first ITSM information or documentation related to resolution of requests;
receive a second request in a second ITSM system that is to replace the first ITSM system;
generate a potential resolution to the second request based on the knowledge base; and
provide the potential resolution in the second ITSM system.

19. The non-transitory computer readable medium of claim 18, wherein the instructions when executed by the processor are further to cause the processor to:
access a result of the potential resolution; and
update the knowledge base based on the result.

20. The non-transitory computer readable medium of claim 19, wherein the instructions when executed by the processor are further to cause the processor to:
containerize, at the first ITSM system, a service used in the first ITSM system; and
execute the containerized service based on the first ITSM information.
